(19) United States
(12) Patent Application Publication
(10) Pub. No.: US 2005/0010338 A1
(43) Pub. Date: Jan. 13, 2005

(54) Method and system for controlling locomotives

(76) Inventors: Mark Bradshaw Kraeling, Melbourne, FL (US); David Michael Peltz, Melbourne, FL (US); Glen Paul Peltonen, Melbourne, FL (US); James Kiss, Melbourne, FL (US); Ajith Kuttannair Kumar, Erie, PA (US); Stephen Matthew Pelkowski, Erie, PA (US); Bradley Charles Hendrickson, Erie, PA (US); Gerald James Hess JR., Erie, PA (US); Daniel Malachi Ballesty, Wattsburg, PA (US); Jeffrey James Kisak, Erie, PA (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/850,992

(22) Filed: May 21, 2004

Related U.S. Application Data
(60) Provisional application No. 60/474,151, filed on May 22, 2003.
(60) Provisional application No. 60/528,021, filed on Dec. 9, 2003.

(51) Int. Cl. G06F 7/00; G01C 21/26

(52) U.S. Cl. 701/19; 701/213

(57) ABSTRACT

A method and system (10) for self-directed operation of a locomotive (12) in a rail yard (82) using a control system (64) on the locomotive for controlling locomotive operations. The method includes establishing at least one operational area (e.g. 74, 76, 78) within the rail yard and associating an operational parameter with each area. The method also includes operating the locomotive using the control system and sensing a location of the locomotive within an operational area. The method further includes determining whether the locomotive is operating within the operational parameter established for the area of its location. If the locomotive is determined not to be operating within the operational parameter, an operation of the locomotive is automatically controlled to operate within the respective operational parameter, without operator input to the control system. The system includes a location detector (62) in communication with the control system to automatically control locomotive operation.

This application claims priority to U.S. Provisional Application Ser. No. 60/474,151, filed on May 22, 2003 and U.S. Provisional Application Ser. No. 60/528,021, filed on Dec. 9, 2003, both of which are incorporated herein by reference.

### FIELD OF THE INVENTION

This invention relates generally to the field of locomotives, and more particularly to automatically controlling locomotives in a rail yard responsive to a sensed position of the locomotive.

### BACKGROUND OF THE INVENTION

It is known to remotely control locomotives in a rail yard using remote radio transmitting devices controlled by rail yard personnel. Such systems may include an operator control unit (OCU) or control tower unit in remote communication with a locomotive control unit (LCU) on board the locomotive. The LCU directs the locomotive to move and stop according to transmitted commands. However, such systems typically require rail yard personnel to actively control movement of the locomotive via the OCU. To reduce demands on the operator, a degree of automated remote control would be desired. Further, securing the operation of the locomotive by restricting its movement to the rail yard (or permitted areas within the yard) would be of added value for safety purposes.

### BRIEF DESCRIPTION OF THE DRAWINGS

The invention will be more apparent from the following description in view of the drawings that show:

FIG. 1 shows a system for remotely controlling a locomotive in response to movement information encoded in transponders positioned along the track.

FIG. 2 shows a diagram of transponder positioning along a rail line to indicate location of a yard limit.

FIG. 3 shows a diagram of transponder positioning along rail lines in a pullback region of a rail yard.

FIG. 4 shows a system for remotely controlling a locomotive within operational areas established in rail yard.

### DETAILED DESCRIPTION OF THE INVENTION

It is known to track train cars using automatic equipment identifier (AEI) systems that include a transponder mounted to each car as well as each locomotive in the train. A transponder reader is positioned at a strategic point along the rail to identify each transponder-equipped car when the car passes the reader. However, control of the operation of the movement of the train based on such information requires a complex communications and data processing network, which often involves operator interaction.

In contrast, the present inventors have innovatively realized that transponders may be placed at strategic locations along a rail track and encoded with desired locomotive movement information, for example, corresponding to the location of the transponder, and used to provide another mode of operation that is more direct. A locomotive configured with a reader may receive the movement information from each of the transponders that the locomotive passes and movement of the locomotive may be controlled according to the information received. Advantageously, movement of trains, such as through a train yard, may be at least partially automated to reduce the workload on remote control operators and to increase safety by automatically invoking safe operating conditions depending on the location of the locomotive within a rail system. Further, such information is available to be transmitted to the operator to notify the operator of the requirements of locomotive operation. Accordingly, self-directed operation of a locomotive in a rail yard may be implemented using a control system on the locomotive for controlling locomotive operations responsive to a location, such as a location of a detected transponder, within the rail yard.

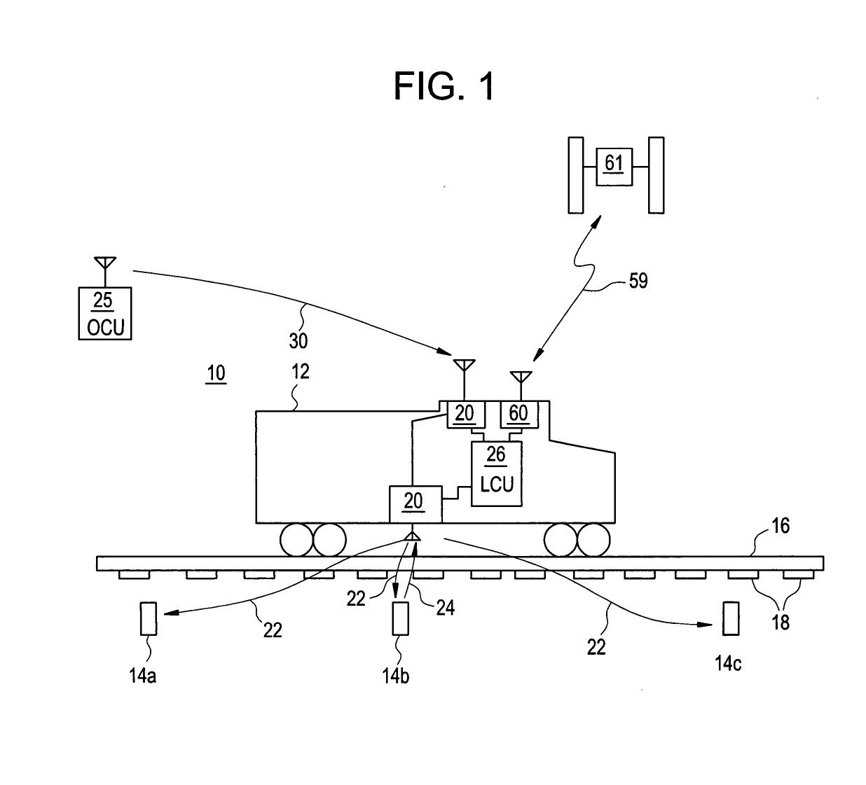

FIG. 1 shows a system 10 for remotely controlling a locomotive 12 in response to movement information encoded in transponders 14a, 14b, 14c positioned along the track 16. In general, transponders 14a, 14b, 14c, such as AEI tags (commercially available, for example, from Transcore, Incorporated) are positioned in the bed of the track 16 at a location where a locomotive operating condition is desired to be controlled. For example, transponder 14 may be attached to a tie 18 located at an entrance to a rail yard area to limit the speed of locomotive 12. The locomotive 12 may be equipped with a transponder reader 20 to read the information encoded in each transponder 14a, 14b, 14c that locomotive 12 passes while traveling along the rail 16. While the following describes a reader 20 located on the locomotive 12, it should be understood that the reader 20 may be installed on any car or locomotive on a train. In some instances, the locomotive operates without an attached car or another locomotive, and thus the locomotive itself then constitutes the train. The reader 20 may be configured to provide control information read from a transponder 14a, 14b, 14c to a controlling locomotive of the train, or to a remote control operator.

In one embodiment, the reader 20 may radiate a radio frequency (RF) activation signal 22 that is received by the transponder 14b. The activation signal 22 provides sufficient energy to the transponder 14b to allow the transponder 14b to radiate a transponder signal 24 back to the reader 20. The transponder signal 24 may typically be an RF signal having a frequency different than that of the activation signal 22. The transponder may also be powered by another suitable source of power, such as batteries, solar power, or a line to a power source. Typically, the reader must be located within a suitable detection distance from the transponder, for example, within 10 feet, to receive the transponder signal 24. Accordingly, transponders may need to be spaced at distances greater than such detection distance to prevent interference among transponders. Unique identifiers for the communication of each transponder with the reader may also be used to allow for closer spacing of transponders.

The reader 20 is in communication with an onboard control system or LCU 26 that controls the locomotive 12 in response to commands received from an operator who may be on-board the locomotive or who may be operating the locomotive remotely via an OCU 25. After reading a transponder, the reader 20 provides the control information encoded in the transponder signal 24 to the LCU 26 to control the operating parameters of the locomotive 12. The locomotive 12 may then maintain these same operating parameters until another transponder 14c is passed, and new control information is received.

The control information received from each transponder 14a, 14b, 14c may be directly provided to the LCU 26 for automatic control of the locomotive 12. In addition, the control information may be provided to a transmitter 28 on board the locomotive 12 to relay the control information to an off-board remote control device, such as an OCU, or a rail yard control tower via a communications link 30. Upon receiving the control information, a remote operator may remotely control the locomotive 12 by sending remote control commands back to locomotive 12 over the communications link 30 in response to relayed control information extracted from the most recently detected transponder 14a, 14b, 14c. The remote operator may use the relayed information to monitor the movement of the locomotive in response to automatic control by the transponders 14a, 14b, 14c and respond with an appropriate remote control command, if necessary.

In an aspect of the invention, two or more sequentially positioned transponders may be configured to provide control information dependent on the direction of locomotive travel with respect to the transponders. For example, two transponders 14a and 14b may provide control information to control the operating parameters of the locomotive 12 if the locomotive 12 is traveling along the rails from transponder 14a to 14b. Conversely, if the locomotive 12 is traveling from transponder 14b to 14a, the locomotive 12 may be instructed by the transponders 14a, 14b to ignore the control information. Such information provided by adjacent transponders may be provided to a remote operator to allow the operator to determine which direction a locomotive 12 is traveling.

Sequentially positioned transponders may be encoded with a distance to a next transponder to provide, for example, a failsafe function if the next transponder expected to be found at the prescribed distance is not detected. The locomotive control unit 26 will monitor the locomotive odometer and will be expecting new transponder instructions within a predetermined distance. If the next transponder is not detected due to a failure of the transponder or for any other reason, the locomotive may be instructed to slow down or to stop.

The transponders 14a, 14b, 14c may be encoded with information to control the speed of the locomotive, such as providing information for the locomotive 12 to maintain a desired speed, a range of speeds, or not to exceed a maximum speed or to fall below a minimum speed. For example, a transponder within a rail yard may instruct the locomotive 12 to stop at a desired location, and after a predetermined time period, to resume moving at predetermined speed. The control information may be used to automatically control the speed and movement of the locomotive 12. The control information may also, or alternatively, be relayed to a remote operator. The relayed control information may be used to control the locomotive 12 in response to the control information, or to monitor the movement of the locomotive 12 in response to automatic commands provided by the transponder. Speed control transponders may be placed in designated speed restriction areas, such as at railway crossings, with “resume speed” transponders located at the borders of the speed restriction area to allow the locomotive 12 to resume a higher speed as the locomotive 12 exits the speed restriction area.

In another aspect, the transponders may be encoded with control information to notify the LCU 26 how to respond to other received control information, such as rail yard control signals or OCU control signals. Accordingly, locomotive control commands received from other sources may be updated or modified to control locomotive movement depending on the locomotive's location. For example, an operator's commands to increase speed while in a transponder controlled speed restriction zone may be overridden if the command received may cause the locomotive to increase its speed to a speed exceeding a speed restriction.

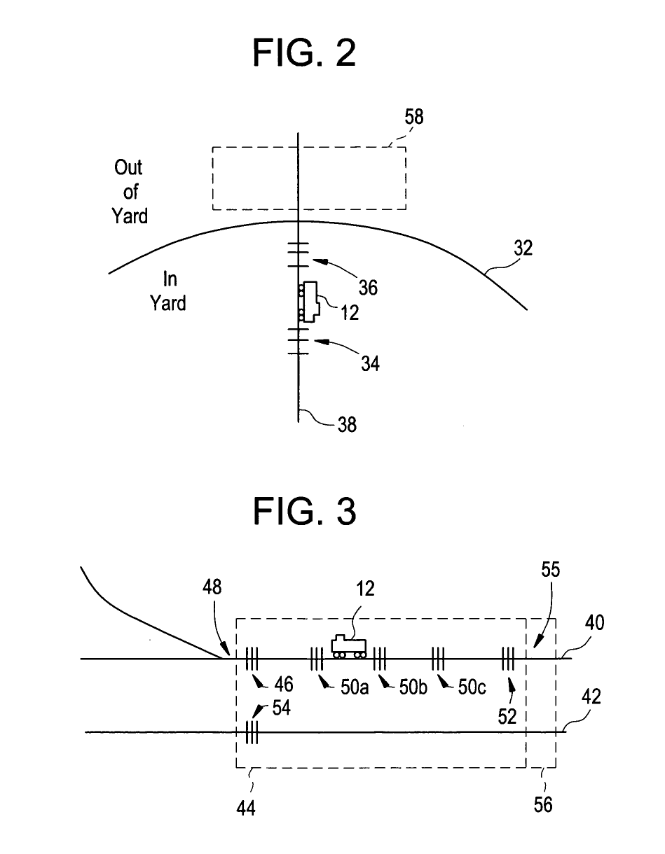

In an exemplary embodiment, the above-described system 10 may be used for rail yard containment of locomotives. FIG. 2 shows a diagram of transponder positioning along a rail line 38 to indicate location of a yard limit 32. A containment warning transponder, or set 34 of containment warning transponders may be positioned sufficiently close to the yard limit 32 to provide control information to slow a locomotive headed in a direction out of the yard as the locomotive passes the set's 34 location. The set 34 may comprise a pair of relatively closely spaced transponders that may be positioned and encoded to provide control information corresponding to a direction that a locomotive 12 is traveling with respect to the locations of the set 34 of transponders. In addition, a third transponder, for example, positioned between the pair, may be provided for redundancy if another transponder in the set 34 fails, is damaged or is accidentally removed.

The containment control information provided to the locomotive 12 by the set 34 may be relayed to a remote controller operator to allow the operator to take appropriate action to control the locomotive 12. The position of the set of transponders 34 in relation to the yard limit may be far enough away from the yard limit so that control information provided by the set 34 to the locomotive may be provided in sufficient time to allow the locomotive 12 to be stopped before exiting the yard. In addition to the set 34 of containment warning transponders, a containment violation transponder, or set 36 of containment violation transponders, may be located closer to the yard limit than the set 34 of warning transponders. The set 36 of containment violation transponders may provide control information to stop a locomotive 12 headed in a direction out of the yard as the locomotive 12 passes the set's 36 location. The position of the set 36 in relation to the yard limit may be far enough away from the yard limit so that control information provided to the locomotive 12 may be provided in sufficient time to allow the locomotive 12 to stop before exiting the yard.

The sets 34, 36 of transponders may be encoded to provide different control information depending on a direction of travel of a locomotive 12 with respect to the transponders. For a locomotive 12 traveling out of the yard, or in an outbound direction, the transponders may provide control information to stop the locomotive 12 if it approaches too close to the yard limit. However, for a locomotive 12 traveling into the yard, or in an inbound direction, the transponders may provide information to instruct the locomotive 12 to ignore the control information, or may provide information to slow the locomotive 12 as it enters the yard. For example, for an inbound locomotive, the set 36 of containment violation transponders may provide information to slow the inbound locomotive to a first speed, and the warning violation transponders may provide information to slow to locomotive to a second speed slower than the first speed.

In another exemplary embodiment, transponders may be programmed with horn and bell function commands to automatically operate a horn and/or bell on a locomotive, such as may be required when the locomotive approaches a rail crossing. Horn and bell command information provided by the transponder may also include a duration time for the horn or bell signal. For example, a transponder, or set of transponders, may be positioned near a rail crossing to automatically invoke a horn signal as the locomotive approaches the crossing. A pair of transponders may be positioned on either side of the crossing and may be configured to provide directional control for operating the horn so that a locomotive approaching the crossing obeys the horn command transponder on the approach side of the crossing and ignores the horn command transponder on the opposite side of the crossing after passing through the crossing. In another form, the horn control command provided by a crossing transponder may be used to provide a horn indication to a locomotive operator to signal the operator to activate the horn.

In yet another exemplary embodiment, the transponder system may be used for automatic or semi-automatic control of pullback operations in a rail switching hump yard. FIG. 3 shows a diagram of transponder positioning along rail lines in a pullback region 44 of a rail yard for providing pullback control of a locomotive 12 for example typically required in humping operations. Transponders may be positioned along a pullback track 40 to control movement of a locomotive 12 on the pullback track 40, such as controlling the direction, speed, movement and location of the locomotive. Sets of three transponders may be spaced along the pull back track 40 at desired locations to provide direction responsive information and transponder redundancy. For example, a set 46 of transponders may be positioned at the start 48 of the pullback track 40. The set 46 may be encoded with control information corresponding to a sequence number for sets of transponders in the pullback region 44 (for example, to identify a locomotive's position on the pullback track 40) and a distance to a next set of transponders. Other sets 50a, 50b, 50c of transponders may be positioned at intervals to provide sequence number, speed, and distance to a next sequential set of transponders. An end of pull back transponder set 52 may be provided at an end 55 of the pullback track 40 and encoded with information to stop the locomotive 12. Accordingly, a remote operator may rely upon the transponders to automatically control the locomotive 12 as it returns to the pullback region 44, instead of being required to control the locomotive until it stops, as required in the past. It should be understood that such automatic locomotive movement control, as described above, may be extended to accomplish automated movement control of a locomotive anywhere on a railway.

In another aspect of the invention, a global positioning system (GPS) 60, responsive to a GPS signal (59) from a GPS satellite (61), may be mounted on the locomotive 12 (as shown in FIG. 1) to work in conjunction with the transponder system 10 to provide another level of redundancy for automatic movement of a locomotive 12. For example, in a yard containment or pullback control application, the GPS 60 may be used to determine the location of the locomotive 12 within predetermined GPS boundaries as a failsafe method if a transponder 14 is misread, defective, missing, or otherwise fails to control the locomotive 12 as required. As shown in FIGS. 2 and 3, GPS areas, such as a yard violation area 58, the pullback region 44, and a “keepout” area 56, may be established to control movement of a locomotive 12 within, into, or out of a respective area 58, 44, 56. If the GPS 60 determines the locomotive 12 has entered or exited any of the predefined areas, an indication of such an occurrence may be provided to the LCU 26 to appropriately control the locomotive 12, or the indication may be relayed to a remote operator to allow the operator to command a corrective action, such as stopping the train, if necessary. The GPS 60 may serve a subsidiary failsafe level in relation to the transponder movement control. Transponder movement control may be assigned a level of control priority superior to GPS control, and a remote controller may have a control priority, or override capability, superior to transponder control. For example, if a transponder positioned to stop a locomotive from exiting a containment yard is not detected, and if the locomotive is not stopped by the transponder control system as a result of not detecting a transponder at a known distance from an adjacent transponder, then a control signal to stop the locomotive may be provided by the GPS system if the locomotive then exits the containment yard and enters a yard violation area. In another aspect depicted in FIG. 3, a transponder, or set 54 transponders, may be provided to override a positioning indication system (such as a GPS) on a track 42 running parallel to the pullback rail 40 by providing a “not a pullback” indication to locomotive if the track encroaches on the pullback region 44 and might incorrectly be considered a pullback rail by the GPS system.

In yet another aspect, transponders may be remotely programmed to change or upgrade control information stored within the transponder for transmission to a reader when radiated. A transponder programmer may be incorporated in a reader to accomplish this task when desired, or a transponder may be remotely programmed via RF, infrared (IR), or hard wire links, or may be configured with removable memory devices. Appropriate security safeguards as would be understood by a skilled artisan may be implemented to prevent unauthorized programming. In one form, a transponder may be programmable to be responsive to a rail switch position. The switch position may be detected and position information may be stored in the transponder to indicate to a locomotive approaching the switch whether the switch is configured in a desired position. If the position information stored in the transponder and provided to the locomotive indicates that the switch is in an incorrect position, the locomotive may be controlled to stop, or an indication of switch position may be provided to the engineer. The transponder may be positioned far enough away from the switch to allow the train to detect the transponder, to receive switch position information, and to allow stopping the train before entering the switch if necessary.

In another form, a transponder may be programmed with train specific information as a train, or lead locomotive of the train passes the transponder. For example, a train length and speed of a passing train may be time-stamped and programmed into the transponder so that the transponder can provide this information to a subsequently passing train to allow the subsequently passing train to maintain a safe distance from the previous train based on the information stored in the transponder. In another aspect, control of remote locomotives in a train may be accomplished using the transponder system. A transponder may be encoded with appropriate remote locomotive control information by a lead locomotive passing the transponder. As a remote locomotive of the train subsequently passes the lead locomotive encoded transponder, the remote can receive the encoded remote locomotive control information and operate according to the received information. For example, if communications between a lead locomotive and one or more remote locomotives in the train are lost, the lead locomotive may use transponders to control the remote locomotive(s).

In another aspect, each transponder may be encoded with a unique identifier. The unique identifier may be associated with desired movement control information corresponding to a positioned location of the transponder within a rail system. The desired movement control information for each transponder a locomotive may detect may be stored on board the locomotive, for example, in a relational database in the LCU, so that each transponder's identifier may be cross referenced to its associated movement control information. Accordingly, as a locomotive passes a transponder and detects the unique identifier of the transponder, the identifier may be cross referenced to the associated movement control information and the control information corresponding to the detected transponder may be used to control the locomotive. Control information associated with respective transponders may be updated or changed, for example, by modifying the control information stored in the database on board the locomotive.

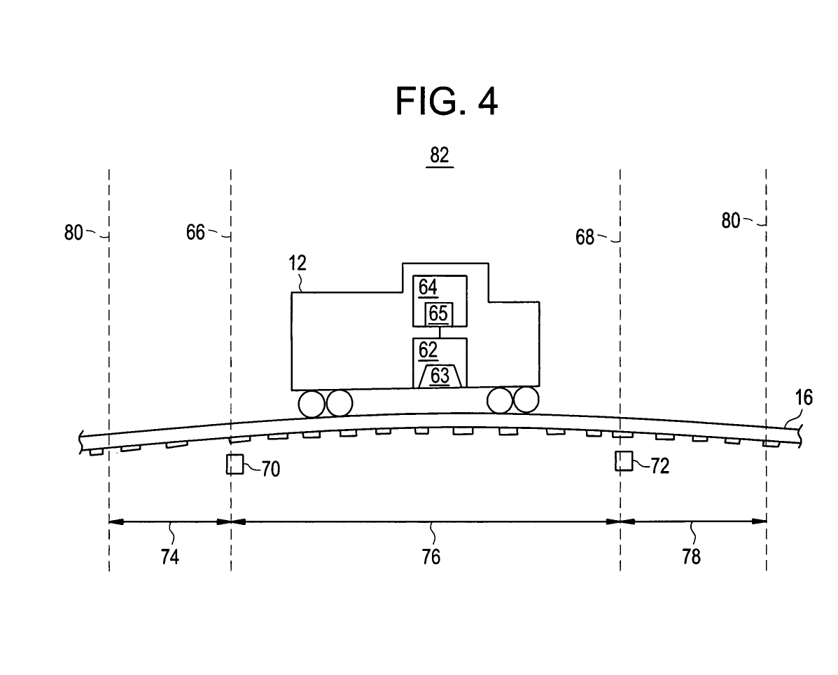

In a general aspect of the invention depicted in FIG. 4, self-directed operation of a locomotive 12 in a rail yard 82 using a controller 64 onboard the locomotive 12 for controlling locomotive operations may be accomplished in response to a location detector 62 determining a location of the locomotive 12. The location detector 62 may be any system configured to determine a location of the locomotive 12. The location of the locomotive 12 may be a specific location, such as a longitude and latitude, or may be a location relative to an operational boundary 66, 68.

In one embodiment, location detector 62 may include a system for receiving a radio frequency signal indicative of the location of the locomotive 12, such as a GPS system providing latitude, longitude, and elevation information. In another embodiment, the location detector 62 may include a transponder reader 63 attached to the locomotive for receiving information from a transponder 70, 72 positioned at a predetermined location proximate the rail track 16. A transponder 70, 72, such as an AEI tag, may transmit information to the transponder reader 63 (configured to receive information from the AEI tag) to provide operational parameters to control the locomotive appropriate for the determined location of the locomotive 12. In yet another aspect, the transponder reader 63 may be configured as a barcode reader for receiving information from a barcode positioned at a predetermined location proximate the rail track 16. In embodiments using transponders or barcode based systems, location of the locomotive 12 may be determined responsive to detection of a certain transponder or barcode, and by knowledge of the location of the certain transponder or barcode. A database (not shown), for example, on board the locomotive 12, or accessible by the locomotive 12, may be provided to allow cross-referencing detected transponders or barcodes with their respective installed locations. In another embodiment, location and/or location appropriate operational information may be encoded in the transponder or barcode and transmitted to the locomotive 12 as it passes.

In addition to being configured to control operation of the locomotive 12 (such as in response to commands provided by an operator off-board the locomotive 12) the control system 64 may include a processor 65 configured to process the location and/or operational information sensed by the location detector 62, and control the locomotive 12 in response to this information. For example, the control system 64 may be configured to control the locomotive 12 responsive to the processor 65, without input from an operator, or may be configured to override an operator command or current locomotive operational parameter if the current operational parameter is outside of the operating parameter required by a sensed location and/or sensed operational parameter.

In a rail yard embodiment, operational areas 74, 76, 78, may be established relative to the rail yard 82. The operational areas 74, 76, 78 may be separated by operation boundaries 66, 68, and may also include a boundary 80 of the rail yard. In an aspect of the invention, each operational area may correspond to respective section of a pullback track. Location of the boundaries 66, 68 may be established by defining boundaries at desired GPS coordinates, or may be identified by transponders 70, 72 positioned proximate respective boundaries, such as sufficiently close to the track 16 to be read by the locomotive 12 as it passes the transponder 70, 72. Accordingly, a locomotive 12 may sense its location within an operation area by determining its location, for example, via receipt of a GPS signal, or by detecting a transponder indicating position within an operational area. Each operational area 74, 76, 78 may be associated with an operational parameter, such as a locomotive speed within an operational area, a direction of movement along a track within an operational area, and an operation authorization within an operational area.

The locomotive 12 may be operated with in the rail yard 82, such as via remote control, using the control system 64 onboard the locomotive 64. As the locomotive travels along the rail 16 in the rail yard 82, the location detector 62 senses a location of a locomotive 12 within an operational area 74, 76, 78. Upon sensing that the locomotive 12 has moved within an operational area having certain associated operational parameters, the processor 65 of the control system 64 may determine whether the locomotive 12 is operating within the operational parameter established for the operation area of its location, such as by comparing the locomotive's 12 current or commanded operational parameters with the required operation parameters established for that operation area. If the locomotive 12 is determined not to be operating within the required operational parameter, the controller 64 may be configured to automatically control an operation of the locomotive to operate the locomotive 12 within the respective operational parameter, without operator input to the control system or to prevent the operator from implementing operational parameters outside the required operational parameters. For example, a sensed speed operational parameter for an operational area may require the controller 64 to adjust a throttle setting and or brake setting to bring the locomotive within the required operational parameter. In another aspect, an operational area may have an associated operation authorization to restrict operation of the locomotive 12 to only an authorized locomotive operator. For example, an operator may be required to provide an access code or key to allow the operator to control the locomotive 12 within the operational area.

While the preferred embodiments of the present invention have been shown and described herein, it will be obvious that such embodiments are provided by way of example only. Numerous variations, changes and substitutions will occur to those of skill in the art without departing from the invention herein.

1. A method for self-directed operation of a locomotive in a rail yard using a control system on the locomotive for controlling locomotive operations comprising:
establishing at least one operational area within the rail yard;
associating an operational parameter with each operational area;
operating the locomotive within the rail yard using the control system;
sensing a location of the locomotive within the operational area;
determining whether the locomotive is operating within the operational parameter established for the area of its location; and
if the locomotive is determined not to be operating within the operational parameter, automatically controlling an operation of the locomotive to operate within the respective operational parameter, without operator input to the control system.

2. The method of claim 1, wherein the operational parameter is selected from the group consisting of a speed within the operational area, a direction of movement along a track within the operational area, and an operation authorization within the operational area.

3. The method of claim 2, further comprising restricting operation of the locomotive to only an authorized locomotive operator.

4. The method of claim 1, wherein the step of sensing comprises receiving a transmitted signal indicative of the location of the locomotive.

5. The method of claim 4, wherein the transmitted signal comprises a radio frequency signal.

6. The method of claim 5, wherein the radio frequency signal comprises a global positioning satellite (GPS) signal.

7. The method of claim 5, wherein the radio frequency signal comprises a transponder signal.

8. The method of claim 1, further comprising:
positioning a transponder encoded with information associated with an operational parameter proximate a rail track at an operational area boundary; and
transmitting the information from the transponder to a processor on the locomotive passing the transponder for use during the step of determining.

9. The method of claim 8, further comprising:
including a unique identifier in the information transmitted from the transponder; and
associating the unique identifier with a respective operational parameter.

10. The method of claim 8, further comprising:
including an operation authorization indicative of a restriction on operation of the locomotive in the information transmitted from the transponder; and
restricting operation of the locomotive to only an authorized locomotive operator.

11. The method of claim 1, further comprising:
positioning a transponder encoded with information associated with an operational parameter proximate a rail track and spaced away from an operational area boundary; and
transmitting the information from the transponder to a locomotive passing the transponder to automatically prevent the locomotive from passing beyond the operational area boundary.

12. The method of claim 1, further comprising:
spacing a plurality of transponders encoded with respective locomotive operational parameters along a rail pullback track to define a plurality of pullback operational areas; and
transmitting respective operational parameters from each transponder to a locomotive moving along the rail pullback track and passing the transponders.

13. The method of claim 12, further comprising automatically controlling movement of the locomotive in response to the operational parameters received from the respective transponders so as to control operation of the locomotive in a manner responsive to a direction of movement of the locomotive past the respective transponder.

14. A system for self-directed control of operation of a locomotive in a rail yard comprising:
a location detector on the locomotive for determining a location of the locomotive; and
a control system on the locomotive in communication with the location detector and responsive to the sensed location of the locomotive to automatically control the operation of the locomotive in the rail yard without operator input.

15. The system of claim 14, wherein the location detector comprises:
a transponder encoded with information positioned at a predetermined location proximate a rail track; and
a transponder reader attached to the locomotive receiving the information from the transponder as the locomotive passes the transponder.

16. The system of claim 15, wherein the transponder comprises a radio frequency identification (RFID) tag.

17. The system of claim 15, wherein the transponder reader comprises an RFID tag reader.

18. The system of claim 18, wherein the location detector comprises a GPS receiver carried on the locomotive.

19. A method of controlling operation of a locomotive comprising:
positioning a transponder encoded with first locomotive operation information along a rail;
updating the first locomotive operation information with second locomotive operation information responsive to a first train passing the transponder to generate updated locomotive operation information;
transmitting the updated locomotive operation information from the transponder to a second train passing the transponder; and
controlling operation of the second train responsive to the updated locomotive operation information.

20. A method of controlling the operation of a locomotive comprising:
positioning a transponder along a rail remote from a switch;
encoding the transponder with information responsive to a position of the switch;
transmitting the information from the transponder to a locomotive traveling along the rail; and
controlling movement of the locomotive through the switch in response to the information.

21. A method of controlling the operation of a locomotive comprising:
positioning a transponder encoded with locomotive operation information proximate a rail track;
transmitting the locomotive operation information from the transponder to a locomotive passing the transponder; and
providing data indicative of locomotive operation information to an operator of the locomotive.
